(19) United States
(12) Patent Application Publication
(10) Pub. No.: US 2026/0268688 A1
(43) Pub. Date: Sep. 10, 2026

(54) DETECTING ANOMALY IN DRIVING VIDEOS USING VISUAL-LANGUAGE MACHINE LEARNING

(71) Applicant: NEC Laboratories America, Inc., Princeton, NJ (US)

(72) Inventors: Abhishek Aich, San Jose, CA (US); Sparsh Garg, Fremont, CA (US); Manmohan Chandraker, Santa Clara, CA (US); Manyi Yao, Princeton, NJ (US)

(21) Appl. No.: 19/553,943

(22) Filed: Mar. 2, 2026

Related U.S. Application Data
(60) Provisional application No. 63/767,027, filed on Mar. 5, 2025.

(51) Int. Cl. G06V 20/58; B60W 60/00; G06T 5/80; G06T 7/20; G06T 7/50; G06T 7/70

(52) U.S. Cl. CPC G06V 20/58; B60W 60/0015; G06T 5/80; G06T 7/20; G06T 7/50; G06T 7/70; G06T 2207/20081; G06V 2201/07

(57) ABSTRACT

Systems and methods for detecting anomaly in driving videos using visual-language machine learning. Distortion from videos can be removed by rectifying frames from the videos based on estimated camera parameters to obtain rectified videos. Environment data, location data, tracking data, and depth data can be determined from the rectified videos with a vision-language framework (VLF). A structured data file that combines the environment data, location data, tracking data, and depth data can be generated by the VLF. An anomaly report for performing downstream tasks can be generated by a machine learning model based on an instruction code generated with the structured data file.

### RELATED APPLICATION INFORMATION

This application claims priority to U.S. Provisional App. No. 63/767,027, filed on Mar. 5, 2025, incorporated herein by reference in its entirety.

### BACKGROUND

### Technical Field

The present invention relates to video processing with artificial intelligence (AI) and more particularly detecting anomaly in driving videos using visual-language machine learning.

### Description of the Related Art

Artificial intelligence (AI) has been applied to several modalities such as images and videos. For example, with AI, objects can be detected within a scene with low light which would be difficult with a naked eye. This enhances vision of users especially in low light areas or even in scenarios with adverse weather effects such as torrential rain, and blizzards.

### SUMMARY

According to an aspect of the present invention, a method is provided including, removing distortion from videos by rectifying frames from the videos based on estimated camera parameters to obtain rectified videos, determining environment data, location data, tracking data, and depth data from the rectified videos with a vision-language framework (VLF), generating a structured data file that combines the environment data, location data, tracking data, and depth data by the VLF, and generating an anomaly report for performing downstream tasks by a machine learning model based on an instruction code generated with the structured data file.

According to another aspect of the present invention, a system is provided, including a memory device, and one or more processor devices operatively coupled with the memory device to perform operations including, removing distortion from videos by rectifying frames from the videos based on estimated camera parameters to obtain rectified videos, determining environment data, location data, tracking data, and depth data from the rectified videos with a vision-language framework (VLF), generating a structured data file that combines the environment data, location data, tracking data, and depth data by the VLF, and generating an anomaly report for performing downstream tasks by a machine learning model based on an instruction code generated with the structured data file.

According to yet another aspect of the present invention, a non-transitory computer program product is provided including a computer-readable storage medium including a program code, wherein the program code when executed on a computer causes the computer to perform operations including, removing distortion from videos by rectifying frames from the videos based on estimated camera parameters to obtain rectified videos, determining environment data, location data, tracking data, and depth data from the rectified videos with a vision-language framework (VLF), generating a structured data file that combines the environment data, location data, tracking data, and depth data by the VLF, and generating an anomaly report for performing downstream tasks by a machine learning model based on an instruction code generated with the structured data file.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a computer system for detecting anomaly in driving videos using visual-language machine learning, in accordance with one embodiment of the present invention;

FIG. 2 is a block diagram that shows a computer system for detecting anomaly in driving videos using visual-language machine learning, in accordance with an embodiment of the present invention;

FIG. 3 is a block diagram that shows components of a computer system for detecting anomaly in driving videos using visual-language machine learning, in accordance with an embodiment of the present invention;

FIG. 4 is a block diagram that shows an autonomous vehicle for detecting anomaly in driving videos using visual-language machine learning, in accordance with an embodiment of the present invention;

FIG. 5 is a flow diagram that shows a high-level overview of detecting anomaly in driving videos using visual-language machine learning, in accordance with an embodiment of the present invention; and

FIG. 6 is a block diagram that shows a practical application of detecting anomaly in driving videos using visual-language machine learning, in accordance with an embodiment of the present invention.

### DETAILED DESCRIPTION OF PREFERRED EMBODIMENTS

In accordance with embodiments of the present invention, systems and methods are provided for detecting anomaly in driving videos using visual-language machine learning.

In an embodiment, distortion from videos can be removed by rectifying frames from the videos based on estimated camera parameters to obtain rectified videos. Environment data, location data, tracking data, and depth data can be determined from the rectified videos with a vision-language framework (VLF). A structured data file that combines the environment data, location data, tracking data, and depth data can be generated by the VLF. An anomaly report for performing downstream tasks can be generated by a machine learning model based on an instruction code generated with the structured data file.

Advanced Driver Assistance Systems (ADAS) are designed to enhance vehicle safety and driving convenience by offering features such as automatic braking, lane-keeping assistance, adaptive cruise control, and collision avoidance. However, despite their technological advancements, ADAS can occasionally produce errors. These issues can become more pronounced when the ADAS system encounters unusual circumstances, such as adverse weather conditions like heavy rain, fog, or snow. Under such conditions, the system may struggle to detect rarely encountered objects in traffic, such as animals, construction vehicles, or pedestrians unexpectedly stepping into the road. Poor road conditions, such as damaged traffic signs, potholes, or vehicles making erratic maneuvers, can also confuse ADAS systems, leading to inaccurate responses.

While ADAS significantly improves vehicle safety, the possibility of occasional errors underscores the need for drivers to remain attentive and responsible. With ADAS becoming increasingly reliant on artificial intelligence and machine learning, it is crucial to thoroughly analyze these systems to identify failure cases and understand the reasons behind them. However, current methods for identifying where ADAS fails are labor-intensive and inefficient, often requiring humans to manually sift through thousands of hours of video footage. This process not only consumes valuable time but also leads to wasted efforts, making it clear that more effective tools and techniques are needed to streamline the detection of ADAS failures.

Some solutions utilize end-to-end vision language models (VLMs) to resolve the issues. However, VLMs are not inherently designed to handle long sequences of frames in a video, enforce temporal consistency across object detections of track motion over time, extract granular object properties, or provide ego-vehicle information. Additionally, incorporating new functionality without requiring extensive retraining of fine-tuning is difficult with VLMS. Furthermore, VLMs struggle with estimating distances, determining lane occupancy, and identifying vehicle movement patterns, including turning, accelerating, or stopping.

To resolve these issues, the present embodiments combine computer vision models with vision-language models (VLMs) to extract detailed, vision-based information from the videos. This visual information is then converted into text and fed into large language models (LLMs) for event analysis. The present embodiments leverage the strengths of vision models to reduce system complexity and computational resource (e.g., processor and memory) utilization for image/video processing by processing complex visual data directly from videos to determine anomalies (e.g., including unusual, particularly long-tail, rare occurrences) which would require extensive training datasets and iterative training to detect. This integration allows us to harness the power of both visual and language-based processing for more accurate and insightful event analysis.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

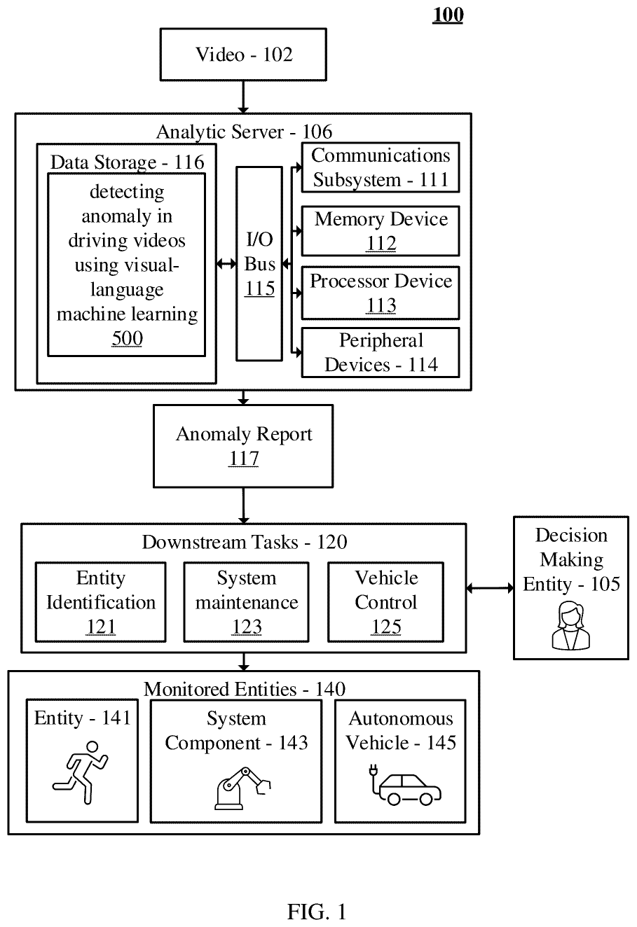

Referring now in detail to the figures in which like numerals represent the same or similar elements and initially to FIG. 1, a block diagram shows a computer system for detecting anomaly in driving videos using visual-language machine learning, in accordance with one embodiment of the present invention.

In an embodiment using a system 100, monitored entities 140 can include entity 141, system component 143, and autonomous vehicle 145. The monitored entities 140 can generate a video 102. The video 102 can be transmitted to an analytic server 106 that can implement detecting anomaly in driving videos using visual-language machine learning 500. The analytic server 106 can generate an anomaly report 117 which can be utilized to perform downstream tasks 120.

System 100 can be utilized to perform downstream tasks 120 based on the video 102 and user query 104 from a decision-making entity 105. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the video 102 or text description 103 (e.g., location images, scene images, entity images such as parts of the entity, etc.) related to the entity 141 can be processed by the analytic server 106 to answer user query 104 based on the anomaly report 117 by the analytic server 106. The user query 104 can be relevant to the entity 141 such as their attributes (e.g., position, direction of movement, color of clothing, etc.), relationship with other entities within a scene (e.g., proximity, behavior, etc.), relationship with the environment, etc. The analytic server 106 can predict future attributes, and relationships of the entity 141.

Based on the predictions of the analytic server 106, a corrective action can be generated by the analytic server 106. The corrective action can include notifying the decision making entity 105 of the predictions about the entity 141 based on their video 102, generating resolutions to an issue caused by the entity (e.g., the entity 141 as a disabled vehicle in a traffic scene and the resolution is the deployment of a repair technician, etc.) of the video 102 to help with the decision making process of the decision making entity 105, etc.

In system maintenance 123, video 102 related to the system component 143 can be processed to answer user query based on based on the anomaly report 117 for the system component 143 generated by the analytic server 106. The user query 104 can be relevant on how to properly maintain the system component 143, or whether the system component is properly functioning based on the input video 102. A corrective action can be generated by the analytic server 106 which can include the answer to the user query (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, redirecting processing of component, etc.) the network system can be autonomously maintained.

In vehicle control 125, video 102 (e.g., vehicle part status, traffic scene image, etc.) related to the autonomous vehicle 145 can be processed to answer user query. The user query 104 can be relevant to how to control the autonomous vehicle 145 given its environment based on the video 102 or text description 103. A corrective action can be generated by the analytic server 106 which can include the answer to the user query to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory based on the anomaly report 117 generated by the analytic server 106 such as multi-vehicle collisions, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate training data.

Other downstream tasks and practical applications are contemplated.

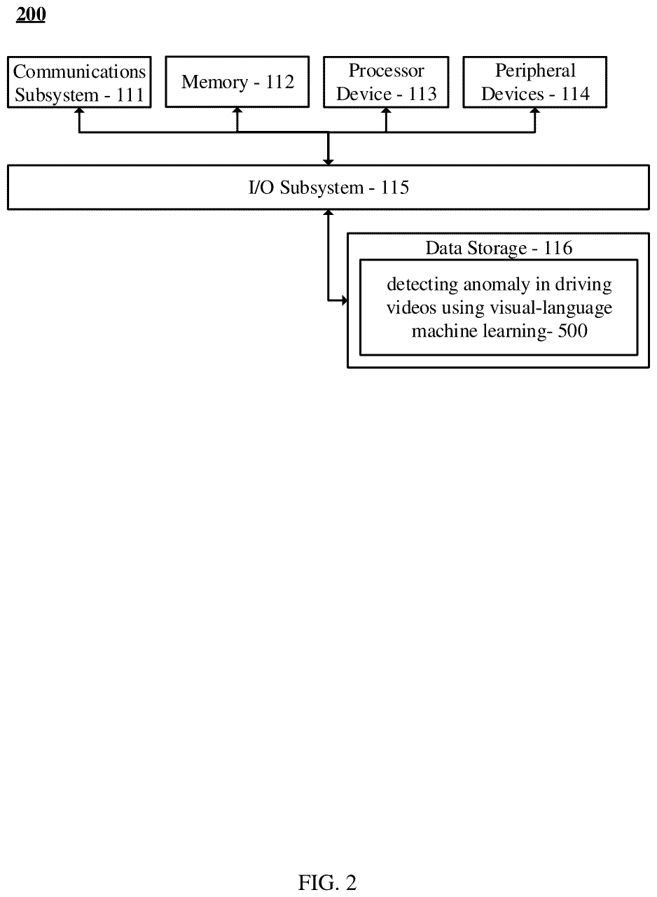

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for detecting anomaly in driving videos using visual-language machine learning, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for detecting anomaly in driving videos using visual-language machine learning 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

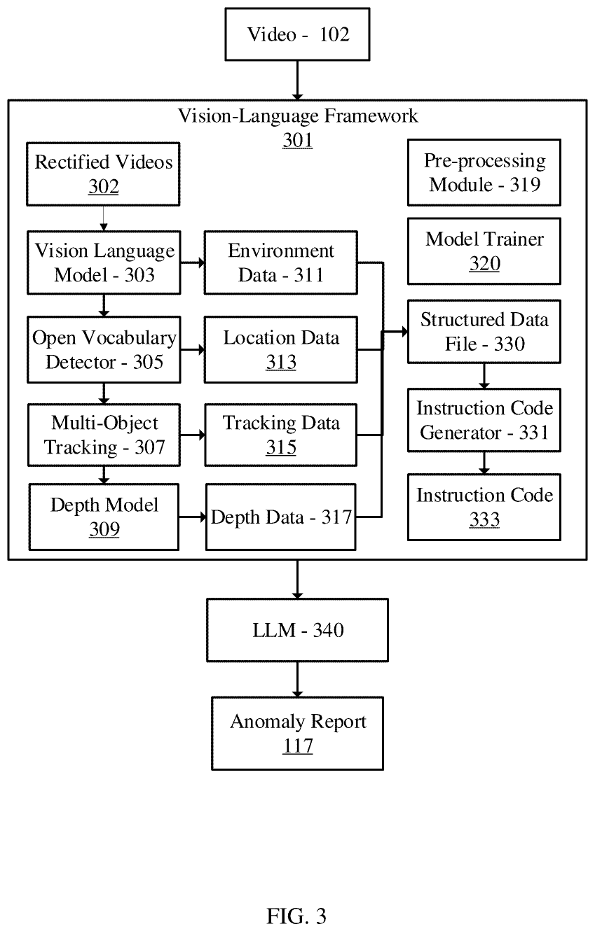

Referring now to FIG. 3, a block diagram shows components of a computer system for detecting anomaly in driving videos using visual-language machine learning, in accordance with an embodiment of the present invention.

In an embodiment, video 102 can be processed by a vision-language framework (VLF) 301 to generate an instruction code 333 to instruct a large language model (LLM) 340 to generate the anomaly report 117.

The VLF 301 can include a vision language model 303, an open vocabulary detector 305, multi-object tracker 307, and depth model 309. The model trainer 320 can train the vision language model 303, an open vocabulary detector 305, multi-object tracker 307, and depth model 309 with the video 102. The vision language model 303, an open vocabulary detector 305, multi-object tracker 307, and depth model 309 can utilize neural networks.

The vision language model 303 can analyze the overall context of the video to extract environment data 311 such as weather conditions, road structure, and the presence of different objects in the scene. This allows for a more holistic interpretation of the environment, supporting diverse reasoning tasks.

The open vocabulary detector 305 can obtain location data 313 which can identify and localize objects such as vehicles and pedestrians within the image frame, serving as the foundation for scene analysis and object tracking. The open vocabulary detector 305 can recognize and model lane boundaries, providing essential insights into road structure and traffic constraints. This allows for understanding lane occupancy, road layout, and driving conditions.

The multi-object tracker 307 can obtain tracking data 315 which can include three-dimensional (3D) object detection estimates the real-world spatial location, dimensions, and orientation of objects, crucial for understanding their movement and interactions within the environment.

Depth model 309 can obtain depth data 317 which can estimate the distance of each detected object relative to the sensors that obtain the video 102, aiding in assessing collision risks and spatial reasoning for downstream applications.

The VLF 301 combines the environment data 311, location data 313, tracking data 315 and depth data 317 to generate a structured data file 330. The structured data file 330 can be converted into natural language by the VLF 301 to enable the instruction code generator 331 to generate the instruction code 333.

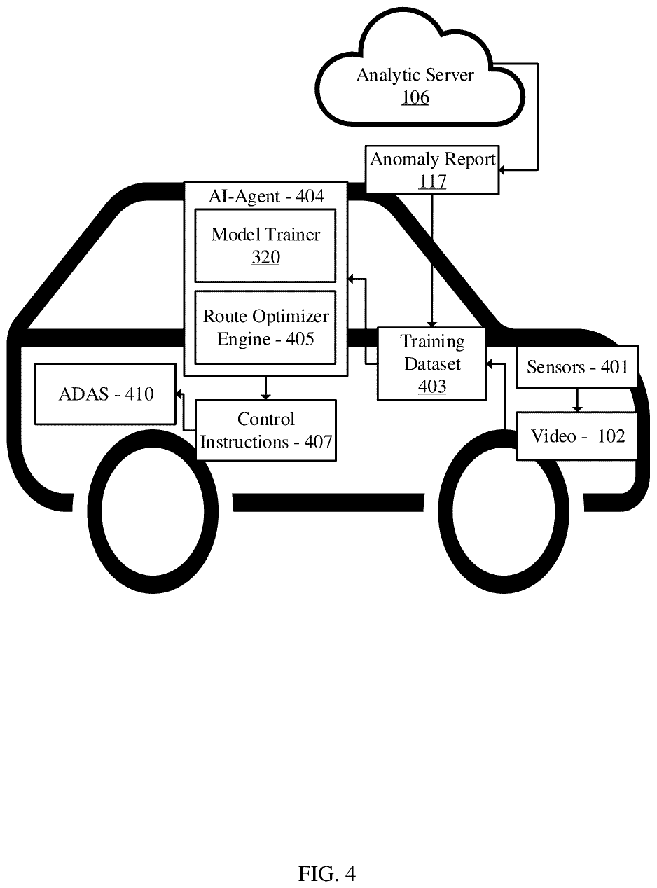

Referring now to FIG. 4, a block diagram that shows an autonomous vehicle for detecting anomaly in driving videos using visual-language machine learning, in accordance with an embodiment of the present invention.

In an embodiment, autonomous vehicle 145 can generate control instructions 407 to control itself with the advanced driver assistance system (ADAS) 410. The route optimizer engine 405 of the autonomous vehicle 145 can generate the control instructions 407 based on obtained video 102 by the sensors 401 of the autonomous vehicle.

In another embodiment, video 102 obtained by the sensors 401 can be utilized with the anomaly report 117 from the analytic server 106 to generate a training dataset 403 to train the route optimizer engine 405. The model trainer 320 can train the route optimizer engine 405 continuously as new video 102 is obtained in real time. The route optimizer engine 405 and the model trainer 320 can be included in an artificial intelligence (AI) agent 404 that can process user queries provided by a decision making entity 105 (e.g., driver, passenger, owner, etc.).

The route optimizer engine 405 can utilize reinforcement learning to generate the control instructions 407 to avoid a detected undesirable event (e.g., collision). The route optimizer engine 405 can utilize neural networks.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network, such as a multilayer perceptron, can have an input layer of source neurons, one or more computation layer(s) having one or more computation neurons, and an output layer, where there is a single output neuron for each possible category into which the input example could be classified. An input layer can have a number of source neurons equal to the number of data values in the input data. The computation neurons in the computation layer(s) can also be referred to as hidden layers, because they are between the source neurons and output neuron(s) and are not directly observed. Each neuron in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons in the one or more computation (hidden) layer(s) perform a nonlinear transformation on the input data that generates a feature space. The classes or categories may be more easily separated in the feature space than in the original data space.

In an embodiment, the model trainer 320 can train the route optimizer engine 405 with reinforcement learning where a state of the environment can be determined by the model trainer 320 and actions (e.g., simulations of vehicle movement including trajectories, etc.) of the route optimizer engine 405 can be generated based on the state. Rewards can be provided if the actions result in a good outcome (e.g., avoidance of collisions, shorter total distance travelled, etc.). Penalties can be provided if the actions result in a bad outcome (e.g., resulted in collisions, inefficient route taken, etc.). The model trainer 320 trains the route optimizer engine 405 such that rewards are maximized and penalties are minimized.

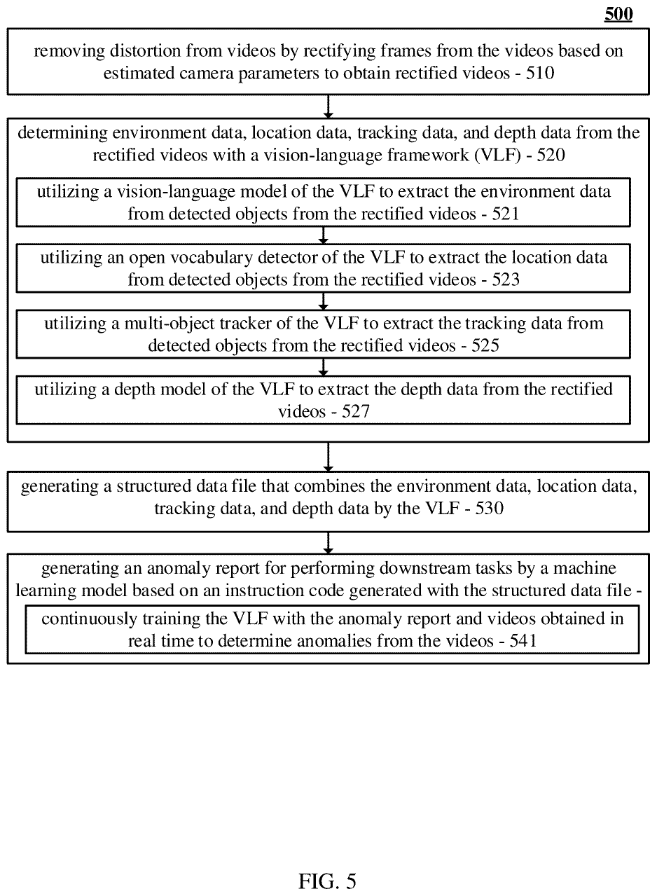

Referring now to FIG. 5, a flow diagram shows a high-level overview of detecting anomaly in driving videos using visual-language machine learning, in accordance with an embodiment of the present invention.

In an embodiment, distortion from videos can be removed by rectifying frames from the videos based on estimated camera parameters to obtain rectified videos. Environment data, location data, tracking data, and depth data can be determined from the rectified videos with a vision-language framework (VLF). A structured data file that combines the environment data, location data, tracking data, and depth data can be generated by the VLF. An anomaly report for performing downstream tasks can be generated by a machine learning model based on an instruction code generated with the structured data file.

In block 510, distortion from videos are removed by rectifying the video frames from the videos based on estimated camera parameters to obtain rectified videos. In an embodiment, distortions can be removed by rectifying the video frames from the videos 102 based on estimated camera parameters. Videos 102 obtained from the front side of vehicles often suffer from distortions due to the characteristics of front-facing cameras. To correct these distortions, the video frames can be rectified based on estimated camera parameters. The camera parameters can include the focal length, optical center, and rotation matrix of the camera used to obtain the videos 102 can be estimated. A vector that models radial distortion and tangential distortion, and the translation vector can be estimated. To rectify the video frames, checkerboard calibration can be utilized. In another embodiment, feature-based analysis can be utilized.

Once the frames are undistorted, a multi-task function, denoted as [symbol] , processes the video and extracts structured outputs that provide a comprehensive understanding of the driving scene. Let a video 102 be represented as a sequence of T frames: v=(I₁, I₂, . . . , I_{T}) where each frame Iₜ ∈ [symbol] ^{H×W×3} is the t-th RGB image of height H and width W. By extracting these structured elements, the VLF 301 enables robust scene interpretation in complex and dynamic driving environments. The structured output for each frame Iₜ can include environment data, location data, tracking data, and depth data.

In block 520, environment data, location data, tracking data, and depth data from the rectified videos can be determined with a vision-language framework.

In an embodiment, attributes of the rectified videos such as environment data, location data, tracking data, and depth data can be determined with a vision-language framework.

In block 521, environment data can be extracted from the rectified videos by utilizing a vision-language model. In an embodiment, the vision language model 303 can analyze the overall context of the rectified video to extract environment data 311 such as weather conditions, road structure, and the presence of different objects in the scene. This allows for a more holistic interpretation of the environment, supporting diverse reasoning tasks.

In block 523, location data can be extracted from the rectified videos by utilizing an open vocabulary detector. In an embodiment, the open vocabulary detector 305 can obtain location data 313 from the rectified videos 302. The open vocabulary detector 305 can identify and localize objects such as vehicles and pedestrians within the image frame, serving as the foundation for scene analysis and object tracking.

The location data 313 can include two-dimensional (2D) bounding boxes and labels for the objects detected within the rectified videos 302.

Two-dimensional (2D) bounding boxes that provide positions of the detected objects can be extracted from the rectified videos with the open vocabulary detector 305. Labels for the detected objects can be extracted from the rectified videos with the open vocabulary detector 305.

In an embodiment, the 2D bounding boxes and labels for the detected objects can be represented as

$${B}_{t} = {\{ ( {b}_{t , i} , {c}_{t , i} ) \}}_{i = 1}^{{n}_{t}}$$

where b_{t,i} ⊂ [symbol] ⁴ is a 2D bounding box parameterized by (xₘᵢₙ, yₘᵢₙ, xₘₐₓ, yₘₐₓ), and c_{t,i} denotes the object class for the i-th detected object in frame t. The location data 313 can include lane markings.

Lane markings can be extracted from the rectified videos 302 by using the open vocabulary detector. In an embodiment, the open vocabulary detector 305 can be utilized to detect lane markings which can output a representation Lₜ ⊂{0, 1}^{H×W} which could take the form of a segmentation mask, polynomial coefficients, or spline parameters describing lane curves on the image plane.

In block 525, tracking data can be extracted from the rectified videos by using the multi-object tracker. In an embodiment, the tracking data 315 can include that tracks of detected objects within the rectified videos 302 across different frames. The tracks can include 2D bounding boxes and class labels of the detected objects.

In block 527, depth data of detected objects can be determined from the rectified videos with a depth model. In an embodiment, the depth data 317 of detected objects can be determined. The depth can include per-object distance from the camera which can be represented as:

$${D}_{t} = {\{ ( {d}_{t , i} ) \}}_{i = 1}^{{n}_{t}} ,$$

where d_{t,i} ∈ [symbol] ⁺ denotes the distance from the dash-cam to the i-th detected object.

In an embodiment, three-dimensional bounding boxes can be extracted from detected objects with depth data 317. For objects with depth information, the position is defined as

$${P}_{t} = {\{ ( {p}_{t , i} , {c}_{t , i} ) \}}_{i = 1}^{{n}_{t}} ,$$

where p_{t,i}⊂ [symbol] ⁷ describes the 3D position and orientation of the bounding box in the scene, parameterized as (X, Y, Z, l, w, h, θ), in a chosen coordinate frame (camera centered or world centered), and c_{t,i} represents the object class.

In block 530, a structured data file that combines the environment data, location data, tracking data, and depth data can be generated. In an embodiment, the structured data file 330 for each frame t can be written as Yₜ=(Bₜ, Pₜ, Lₜ, Dₜ). The structured data file 330 can be written in a structured data representation such as extensible markup language (XML), javascript object notation (JSON), etc.

The structured data file 330 can include a video-level section, an object level section and a frame level section. The video level section can include the environment data. The object level section can include the granular information about the detected objects. The frame level section can include information about the frames of the rectified videos. For example, the structured data file 330 can include a video level section that can include: “weather: ‘sunny’, light: ‘day/night’, linear: ‘arterials/curve/intersection/T-junction/ramp’, environment: ‘city street/country road/highway/residential area’”. The object level section and frame level section can include “Objects: [{track id: 1, class: ‘car’, per frame info: [{frame id: 24, bbox: [*, *, *, *], score: 0.5, depth: 16}, { }, desc: [{description: ‘a dark-colored car . . . ’, view: ‘font’} . . . ]}]”.

The overarching function applied to the videos 102 can be represented as:)

$$ℱ : {ℝ}^{T \times H \times W \times 3} \to {\prod }_{t = 1}^{T} ( ℬ \times 𝒫 \times ℒ \times 𝒟 )$$

such that, [symbol] (v)=(Y₁, Y₂, . . . , Yₜ) where, Yₜ=(Bₜ, Pₜ, Lₜ, Dₜ). Function [symbol] is conceptualized as a single function

$$ℱ ( v ) = {\{ ( {B}_{t} , {P}_{t} , {L}_{t} , {D}_{t} ) \}}_{i = 1}^{{n}_{t}}$$

that takes in input videos and outputs a suite of perception results.

In an embodiment, an instruction code can be generated based on the structured data file to instruct a machine learning model to determine anomalies from the structured data file. In an embodiment, an instruction code 333 can be generated by the instruction code generator 331 to instruct a machine learning model such as LLM 340 to determine anomalies (e.g., including unusual, particularly long-tail, rare occurrences) in videos 102. The instruction code 333 can include sections on how the LLM 340 can determine the anomalies such as prerequisites, heuristics to utilize, output specification, input specification, etc.

In block 540, an anomaly report for performing downstream tasks can be generated by the machine learning model based on an instruction code generated with the structured data file.

In an embodiment, a machine learning model such as LLM 340 can be utilized to generate an anomaly report 117. The anomaly report 117 can include an issue section and a cause section. The issue section describes the anomaly detected within the videos 102. The cause section describes a logical reason as to how the anomaly detected happened within the context of the video. For example, in a video 102 showing a truck merging in multiple lanes erratically, the issue section can include “erratic approach of a large dark-colored truck moving into the ego car's lane.” The cause section can include “the truck is consistently closing in on the lane from various lanes, during overcast weather, potentially due to driver error or unpredictable swerving driving behavior.”

In an embodiment, a training dataset can be generated with data from the anomaly report, the structured data file, and videos obtained in real time. The analytic server 106 can process data from the anomaly report 117, the structured data file 330, and videos 102 to generate the training dataset 403.

In another embodiment, a model trainer 320 can be implemented within the autonomous vehicles 145 to generate the training dataset 403. The training dataset 403 can be utilized by the model trainer 320 to continuously train a route optimizer engine 405 of the autonomous vehicle 145 to generate control instructions 407 for the ADAS 410 of the autonomous vehicle 145. The route optimizer engine 405 can utilize knowledge from the vision-language framework 301. The individual machine learning models of the vision-language framework 301 and the route optimizer engine 405 can be trained independently. In another embodiment, the models can be trained in a joint learning framework.

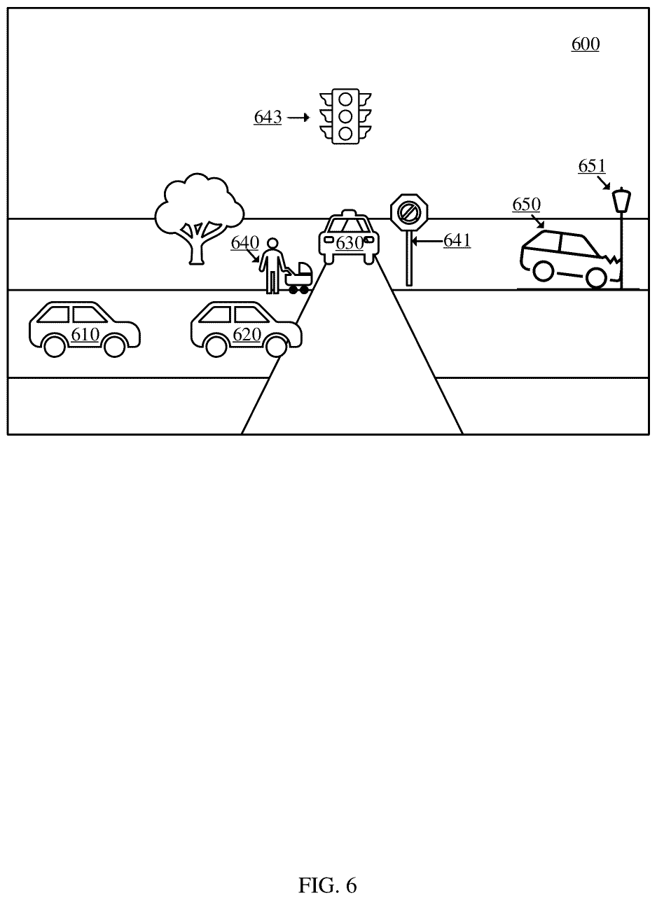

Referring now to FIG. 6, a block diagram shows a practical application of detecting anomaly in driving videos using visual-language machine learning, in accordance with an embodiment of the present invention.

In an embodiment, in traffic scene 600, autonomous vehicle 145 with an AI agent 404 that can utilize analytic server 106 through a network. Input videos 102 can be processed by autonomous vehicle 145 through the analytic server 106 through the network.

The autonomous vehicle 145 can autonomously understand the traffic scene 600 and generate trajectories based on the traffic scene. The trajectories can include predictions of trajectories of the entities in the traffic scene 600 based on user queries. For example, the user queries provided by the decision making entity 105 to the AI agent 404 can include “is there a vehicle in front of us which can potentially collide with another vehicle?”. AI agent 404 can generate a response which can include “No, vehicle (620) is in the intersection where pedestrian (640) is also crossing the intersection. Taxi (630) is stopped behind one-way sign (641) as the light on (643) is red for taxi (630) and green for vehicle (620). A disabled vehicle (650) has already collided with a lamppost (651).”

The AI agent 404 can process the input videos 102 and generate control instructions 407 and control the autonomous vehicle 145 based on input queries and anomaly report 117. The anomaly report 117 can include a rare occurrence between a disabled vehicle 650 and post 651 on a sidewalk. The anomaly report 117 can include an issue section describing “a red truck has lost control and collided with a lamppost at the sidewalk during an overcast day.” The cause section of the anomaly report 117 can include “the red truck has been driving with excessive speed and lost control trying to avoid colliding with a pedestrian trying to cross the intersection.”

In another embodiment, in traffic scene 600, autonomous vehicle 145 can simulate trajectories for the identified entities. In another embodiment, in traffic scene 600, based on the simulated trajectories of the identified entities, autonomous vehicle 145 can generate a trajectory to avoid the simulated trajectories of the identified entities and avoid collisions. In another embodiment, the autonomous vehicle 145 can be autonomously controlled based on the generated trajectory to avoid collisions through autonomous decision making.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method comprising:
removing distortion from videos by rectifying frames from the videos based on estimated camera parameters to obtain rectified videos;
determining environment data, location data, tracking data, and depth data from the rectified videos with a vision-language framework (VLF);
generating a structured data file that combines the environment data, location data, tracking data, and depth data by the VLF; and
generating an anomaly report for performing downstream tasks by a machine learning model based on an instruction code generated with the structured data file.

2. The method of claim 1, wherein determining the environment data further comprises utilizing a vision-language model of the VLF to extract the environment data from detected objects from the rectified videos.

3. The method of claim 1, wherein determining the location data further comprises utilizing an open vocabulary detector of the VLF to extract the location data from detected objects from the rectified videos.

4. The method of claim 1, wherein determining the tracking data further comprises utilizing a multi-object tracker of the VLF to extract the tracking data from detected objects from the rectified videos.

5. The method of claim 1, wherein determining the depth data further comprises utilizing a depth model of the VLF to extract the depth data from the rectified videos.

6. The method of claim 1, further comprising continuously training the VLF with the anomaly report and videos obtained in real time to determine anomalies from the videos.

7. The method of claim 1, further comprising controlling an autonomous vehicle to avoid an undesirable event based on the anomaly report through autonomous decision making.

8. A system, comprising:
a memory device; and
one or more processor devices operatively coupled with the memory device to perform operations including:
removing distortion from videos by rectifying frames from the videos based on estimated camera parameters to obtain rectified videos;
determining environment data, location data, tracking data, and depth data from the rectified videos with a vision-language framework (VLF);
generating a structured data file that combines the environment data, location data, tracking data, and depth data by the VLF; and
generating an anomaly report for performing downstream tasks by a machine learning model based on an instruction code generated with the structured data file.

9. The system of claim 8, wherein determining the environment data further comprises utilizing a vision-language model of the VLF to extract the environment data from detected objects from the rectified videos.

10. The system of claim 8, wherein determining the location data further comprises utilizing an open vocabulary detector of the VLF to extract the location data from detected objects from the rectified videos.

11. The system of claim 8, wherein determining the tracking data further comprises utilizing a multi-object tracker of the VLF to extract the tracking data from detected objects from the rectified videos.

12. The system of claim 8, wherein determining the depth data further comprises utilizing a depth model of the VLF to extract the depth data from the rectified videos.

13. The system of claim 8, further comprising continuously training the VLF with the anomaly report and videos obtained in real time to determine anomalies from the videos.

14. The system of claim 8, further comprising controlling an autonomous vehicle to avoid an undesirable event based on the anomaly report through autonomous decision making.

15. A non-transitory computer program product comprising a computer-readable storage medium including a program code, wherein the program code when executed on a computer causes the computer to perform operations including:
removing distortion from videos by rectifying frames from the videos based on estimated camera parameters to obtain rectified videos;
determining environment data, location data, tracking data, and depth data from the rectified videos with a vision-language framework (VLF);
generating a structured data file that combines the environment data, location data, tracking data, and depth data by the VLF; and
generating an anomaly report for performing downstream tasks by a machine learning model based on an instruction code generated with the structured data file.

16. The non-transitory computer program product of claim 15, wherein determining the environment data further comprises utilizing a vision-language model of the VLF to extract the environment data from detected objects from the rectified videos.

17. The non-transitory computer program product of claim 15, wherein determining the location data further comprises utilizing an open vocabulary detector of the VLF to extract the location data from detected objects from the rectified videos.

18. The non-transitory computer program product of claim 15, wherein determining the tracking data further comprises utilizing a multi-object tracker of the VLF to extract the tracking data from detected objects from the rectified videos.

19. The non-transitory computer program product of claim 15, wherein determining the depth data further comprises utilizing a depth model of the VLF to extract the depth data from the rectified videos.

20. The non-transitory computer program product of claim 15, further comprising controlling an autonomous vehicle to avoid an undesirable event based on the anomaly report through autonomous decision making.
